(19) United States
(12) Patent Application Publication
(10) Pub. No.: US 2017/0133761 A1
(43) Pub. Date: May 11, 2017

(54) VEHICULAR ANTENNA SYSTEM AND VEHICLE

(71) Applicant: Leauto Intelligent Technology (BEIJING) Co., Ltd., Beijing (CN)

(72) Inventors: Taiwei SONG, Beijing (CN); Chao WU, Beijing (CN); Zhong WANG, Beijing (CN)

(21) Appl. No.: 14/970,443

(22) Filed: Dec. 15, 2015

(30) Foreign Application Priority Data
Nov. 11, 2015 (CN) 201510766277.X

(51) Int. Cl. H01Q 5/50; H01Q 1/32; H01Q 5/10

(52) U.S. Cl. CPC H01Q 5/50; H01Q 5/10; H01Q 1/3291

(57) ABSTRACT

A vehicular antenna system is disclosed. The system includes a central control unit and a plurality of antenna modules, wherein the central control unit includes a central processing unit and a plurality of Long Term Evolution (LTE) modules; each of the LTE modules in the central control unit is connected with at least one of the antenna modules; and the plurality of LTE modules are connected respectively with the central processing unit.

### CROSS-REFERENCE TO RELATED APPLICATIONS

This application claims priority to Chinese patent application No. 201510766277.X filed on Nov. 11, 2015 and titled “VEHICULAR ANTENNA SYSTEM”, the content of which is incorporated herein by reference in its entirety.

### FIELD OF TECHNOLOGY

The present disclosure relates to the field of communications and particularly to a vehicular antenna system and vehicle.

### BACKGROUND

Along with the social development, there are a constantly growing level of people's life, and also constantly growing functions and comforts of vehicles as required by people for whom it is desirable to watch videos, to access the Internet at a high speed, and to enable various other Internet related functions in their vehicles, so intelligent vehicles over the Internet will inevitably emerge in the future.

The vehicles can perform these functions only if they receive radio signals through vehicular antennas, so there are an increasing number of required antennas along with emerging functions of the vehicles, e.g., radio, global positioning, mobile TV, mobile communication, and other antennas, but the vehicles are generally provided with single antennas in the prior art, and as can be apparent, the vehicles can not receive the various signals, so their users can not watch videos, access the Internet at a high speed, and enable various other Internet related functions in their vehicles.

### SUMMARY

An embodiment of the disclosure provides a vehicular antenna system including a central control unit and a plurality of antenna modules, wherein:

the central control unit includes a central processing unit and a plurality of Long Term Evolution (LTE) modules;

each of the LTE modules in the central control unit is connected with at least one of the antenna modules; and

the plurality of LTE modules are connected respectively with the central processing unit.

Correspondingly an embodiment of the disclosure further provides a vehicular including the vehicular antenna system.

### BRIEF DESCRIPTION OF THE DRAWINGS

In order to make the technical solutions in the embodiments of the disclosure or in the prior art more apparent, the drawings to which the embodiments or the prior art are described with reference will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 illustrates a schematic structural diagram of a vehicular antenna system according to an embodiment of the disclosure;

FIG. 2 illustrates a schematic structural diagram of an antenna module according to an embodiment of the disclosure;

FIG. 3 illustrates a schematic structural diagram of an antenna module according to an embodiment of the disclosure;

FIG. 4 illustrates a schematic structural diagram of an antenna module according to an embodiment of the disclosure;

FIG. 5A to FIG. 5C illustrate schematic structural diagrams of an antenna module according to embodiments of the disclosure;

FIG. 6 illustrates a schematic diagram of positioned antenna modules according to an embodiment of the disclosure;

FIG. 7 illustrates a schematic diagram of positioned antenna modules according to an embodiment of the disclosure;

FIG. 8 illustrates a schematic diagram of positioned antenna modules according to an embodiment of the disclosure;

FIG. 9 illustrates a schematic diagram of positioned antenna modules according to an embodiment of the disclosure;

FIG. 10 illustrates a schematic structural diagram of a vehicular antenna system according to an embodiment of the disclosure;

FIG. 11 illustrates a schematic structural diagram of a vehicular antenna system according to an embodiment of the disclosure;

FIG. 12 illustrates a schematic structural diagram of a vehicular antenna system according to an embodiment of the disclosure; and

FIG. 13 illustrates a schematic structural diagram of a vehicular antenna system according to an embodiment of the disclosure.

### DETAILED DESCRIPTION OF THE EMBODIMENTS

In order to make the objects, the technical solutions and the advantages of the embodiments of the disclosure more apparent, the disclosure will be further described in details with reference to the drawings. Apparently the described embodiments are only a part but all of the embodiments of the disclosure. Based upon the embodiments of the disclosure here, all of other embodiments derived by those ordinarily skilled in the art without any inventive effort shall come into the scope of the disclosure.

At present, a traditional vehicular antenna system is designed only with Frequency Modulation, Global Positioning System (GPS), Wireless-Fidelity/Bluetooth (WiFi/BT), China Mobile Multimedia Broadcast (CMMB), and other general functions, and the antennas are commonly designed as shark fin antennas, helical antennas, column antennas, etc. Along with the technical development, users desire to perform vehicular video communication, watch high-definition videos, and perform other similar activities through a vehicular center console, where these functions can be performed only if their vehicles can transmit at a high speed over the network.

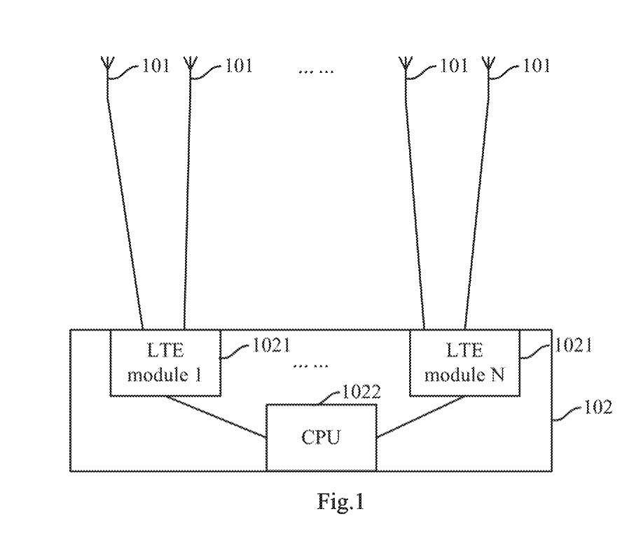

Following the description above, FIG. 1 illustrates a schematic structural diagram of a vehicular antenna system, as illustrated in FIG. 1, which includes:

A central control unit 102, and a plurality of antenna modules 101, and the central control unit 102 includes a Central Processing Unit (CPU) 1022 and a plurality of LTE modules 1021, each of the LTE modules 1021 in the central control unit 102 is connected with at least one of the antenna modules 101, and the plurality of LTE modules 1021 are connected respectively with the CPU 1022.

The plurality of LTE modules 1021 can perform second generation (2G), third generation (3G), and fourth generation (4G) communication, and each of the plurality of LTE modules 1021 can receive and transmit signals through their corresponding antenna modules 101 to communicate with the outer network.

As illustrated in FIG. 1, each of the plurality of LTE modules 1021 is connected with two of the antenna modules 101, which are a primary antenna and a secondary antenna respectively. The LTE module 1021 can alternatively be connected with one of the antenna modules 101, although there will be better communication performance of the LTE module 1021 if there are a larger number of antenna modules 101 connected therewith.

If there is only one LTE module 1021, then the vehicular antenna system may have a higher network transmission speed than in the 2G mode and the 3G mode. If there are a plurality of LTE modules 1021 and a plurality of antenna modules 101, then a vehicle can be provided with high-speed network transmission through the plurality of LTE modules 1021 and a plurality of antenna modules 101 in the vehicular antenna system due to aggregation of a plurality of carriers, to thereby enable vehicular video communication, watch high-definition videos, and perform other similar activities in the vehicle. The embodiment of the disclosure can improve the network transmission speed over the prior art.

The antenna module 101 in the embodiment of the disclosure can be fabricated in a number of process including at least the following several processes:

First Scheme

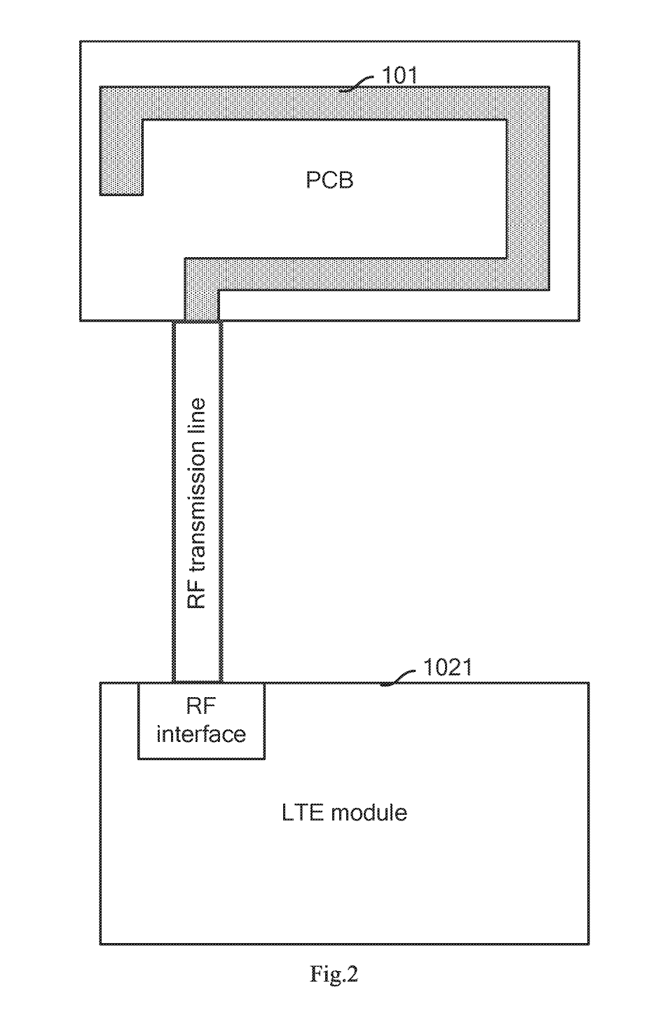

As illustrated in FIG. 2, the antenna module 101 is printed on a first Printed Circuit Board (PCB), where a metal layer of the first PCB is etched in an etching process to form the antenna module 101. Alternatively a pattern of the antenna module 101 can be printed on the first PCB. The antenna module 101 is connected to Radio Frequency (RF) interface through RF transmission line, the RF interface is connected with the LTE module 1021. The LTE module 1021 transmits and receives signals through the antenna module 101. The antenna module 101 fabricated in this way can be simplified in structure as a whole and convenient to install.

Second Scheme

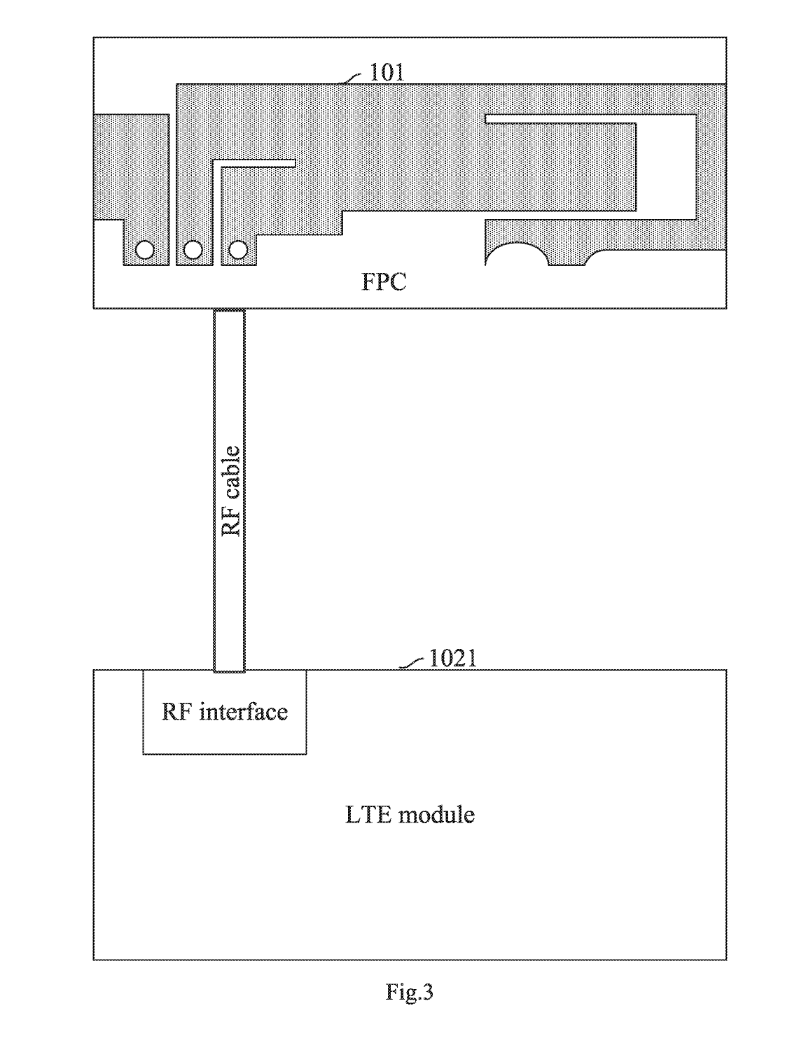

As illustrated in FIG. 3, the antenna module 101 is formed by etching a Flexible Printed Circuit (FPC). The FPC, which is covered by a mask with the antenna pattern, is exposed, and then a metal layer on the exposed FPC is etched, thus the antenna module 101 in the form of a labyrinth is fabricated. The antenna module 101 fabricated with the FPC process is compact in structure and convenient to install, and the FPC can be affixed on the casing of a center console through a back-adhesive, e.g., on the outer casing of the center console, possibly on the outside or the inside of a non-metal portion of the outer casing of the center console, or the FPC can be affixed on a second PCB. The antenna module 101 is connected to RF interface through RF cable, where the RF interface is connected with the LTE module 1021. The antenna module 101 fabricated in this way has the advantage of a high wiring density, a low weight, high bendability, etc.

Third Scheme

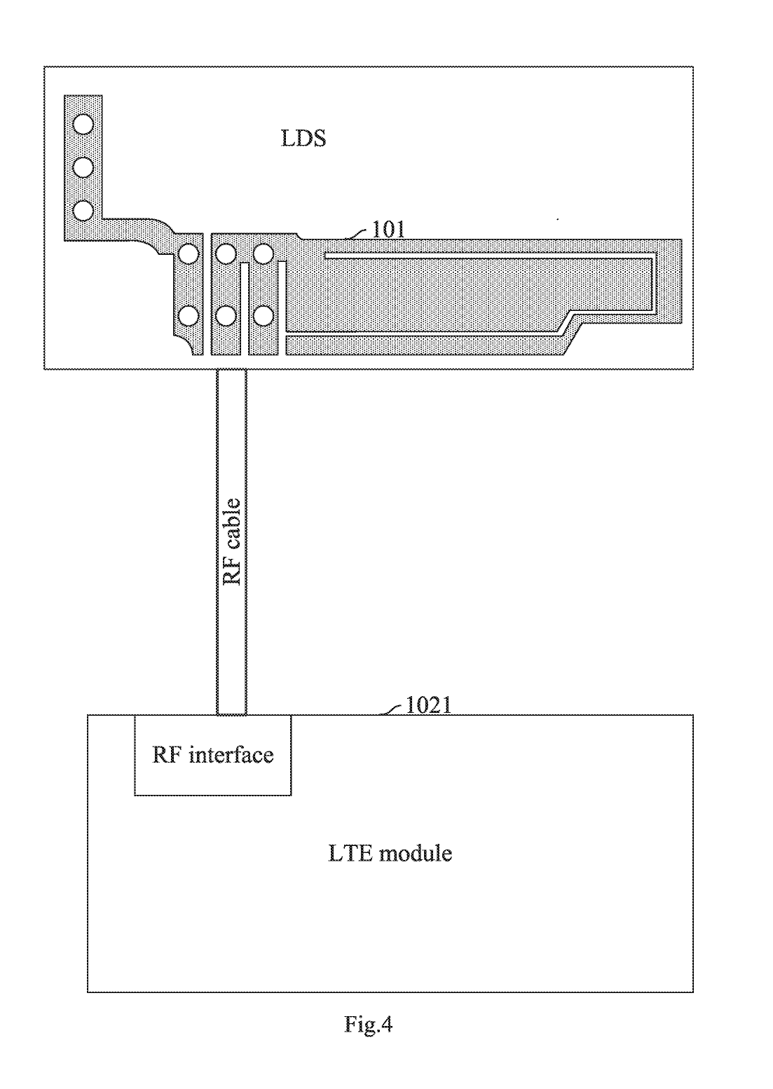

As illustrated in FIG. 4, the antenna module 101 is formed on the casing of a structure piece by laser carving with Laser Direct Structuring (LDS) process. Metal powers are laser carved onto the casing of any structure piece with an LDS process, e.g., on the outer casing of a center console, possibly on the outside or the insides of a non-metal portion of the outer casing of the center console. The antenna module 101 fabricated in this way can be designed with any antenna pattern and formed by laser carving on the casing of a structural piece in any shape flexibly without being restricted by the structural modality of a product, and can be prevented from being interfered by metal in the LTE module 1021, and also the volume of the LTE module 1021 can be lowered. The antenna module 101 is connected to RF interface through RF cable, the RF interface is connected with the LTE module 1021.

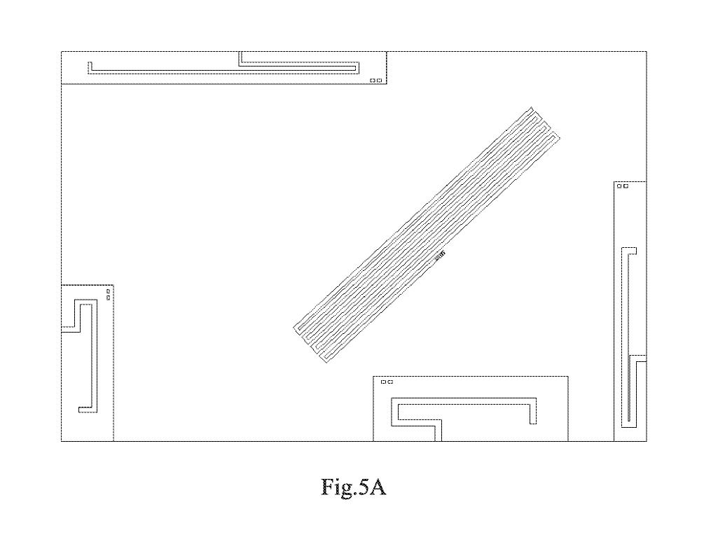

Correspondingly, embodiments of the disclosure further provide schematic structural diagrams of several antenna modules 101 as illustrated in FIG. 5A to FIG. 5C. FIG. 5A illustrates a sectional view of an antenna module 101, i.e., a cross section view of the antenna module 101. As can be apparent from FIG. 5A, the pattern structure of the antenna module 101 is printed on an FPC. FIG. 5B and FIG. 5C illustrate two antenna patterns of antenna module 101, which are an annular structure and a “ [symbol] ”-shaped structure respectively. The antenna module 101 can be fabricated in either of these two patterns, where the FPC is etched in the pattern, thus forming the antenna module 101, or metal powers are laser carved through LDS to form either of the patterns. The pattern of the antenna module 101 can be designed freely in a practical application.

The three schemes above in which the antenna module 101 is fabricated have been described in the embodiments of the disclosure only as examples, but the process in which the antenna module 101 is fabricated will not be limited to these schemes, so the embodiments of the disclosure will not be limited thereto.

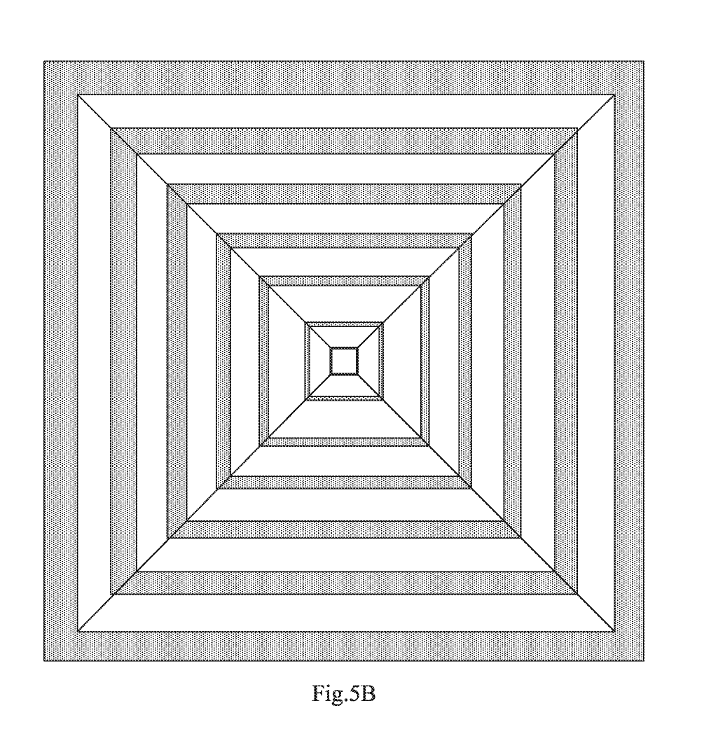

in an embodiment of the disclosure, the antenna modules 101 can be arranged in the center console, and as illustrated in FIG. 6, the pattern of the antenna modules 101 can be formed on the outer casing of the center console by laser carving in the LDS process, possibly on the outside or the inside of the outer casing of the center console. if the outer casing of the center console and a main screen of the center console are stacked and assembled together, and the outer casing is installed separately, then the antenna modules 101 may be arranged on the four sides of the face of the outer casing facing passengers.

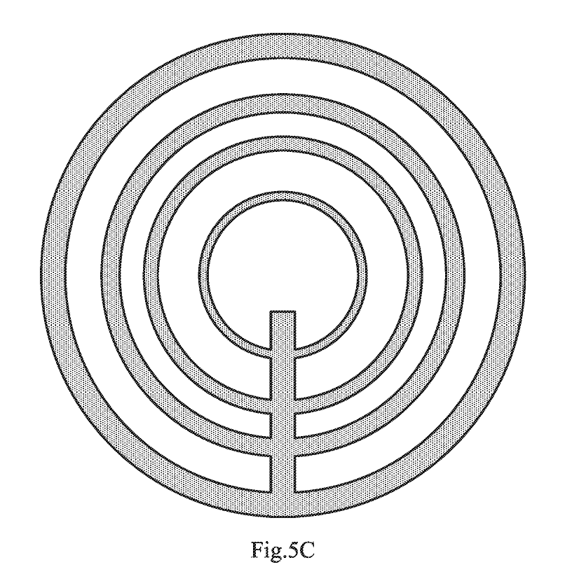

Particularly FIG. 7 illustrates a schematic structural diagram of installation site where antenna modules 101 may be arranged, where the antenna modules 101 can be arranged in the zones delimited by the bold solid lines in black in FIG. 7, that is, at the four corners on the four sides of the outer casing of the center console. There are four antenna modules 101 (including primary and secondary antennas) placed at the eight positions in total at the four corners, and there are the longest distances between the antenna modules 101 at the four corners. Although the distance between the primary and secondary antennas in the antenna module 101 at each of the corners is not the longest, the primary and secondary antennas can be positioned to be horizontal and vertical respectively to thereby facilitate isolation between the polarization directions, so as to achieve good isolation between the two antennas, thus guaranteeing the performance of communication.

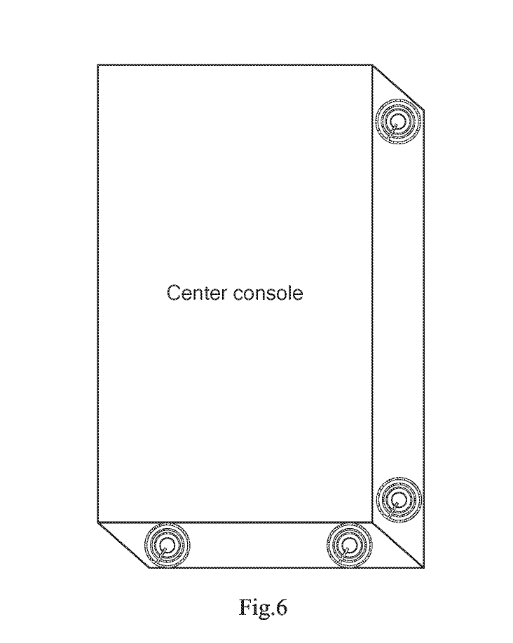

FIG. 8 illustrates a schematic structural diagram of installation site where antenna modules 101 may be arranged, where the antenna modules 101 can be arranged in the zones delimited by the bold solid lines in black in FIG. 8, that is, on the four sides of the outer casing of the center console, at the ⅓ lengths of the sides. There are four antenna modules 101 (including primary and secondary antennas) placed at the eight positions in total, so the distances between the respective antennas can make the antennas spaced the furthest, to thereby guarantee the isolation between the respective antennas and thus the performance of communication.

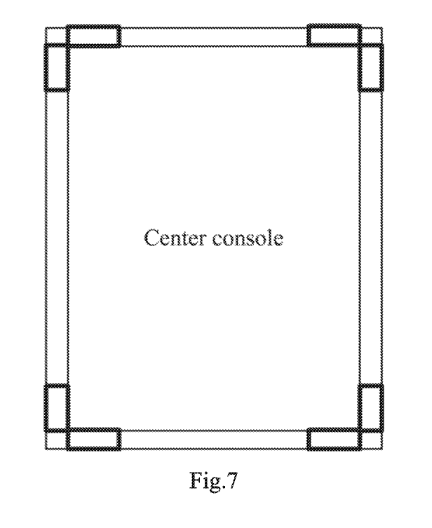

FIG. 9 illustrates a schematic structural diagram of installation site where antenna modules 101 may be arranged, where the antenna modules 101 can be arranged in the zones delimited by the bold solid lines in black in FIG. 9. The shape of the center console is an ellipse, and there are eight positions spaced equidistantly on the periphery of the outer casing of the center console, so there are four antenna modules 101 (including primary and secondary antennas) placed at these eight positions, so that the distances between the respective antennas can make the antennas spaced the furthest to thereby guarantee the isolation between the respective antennas and thus the performance of communication.

Since antenna systems of vehicles in the prior art are designed with single antenna, the vehicles can receive various signals only if a plurality of antennas are installed on the vehicles, but these antennas have to be installed on the outsides of the roofs of the vehicles, thus increasing the instability of the vehicles. Unlike the prior art, the antenna modules 101 can be arranged on the center console of the vehicle according to the embodiments of the disclosure instead of being installed on the outside of the roof of the vehicle to thereby improving the stability of the vehicle.

The primary and secondary antennas in the antenna modules 101 can be designed as directional antennas with a radiation angle being less than or equal to 180°. As compared with the external antennas of the traditional vehicles, there will be higher gains of the directional antennas to thereby improve the efficiency of radiation. The radiation angles and directions of the respective antennas can be designed on purpose so that the radiation directions of the respective antennas can be designed to be oriented toward the windows of the vehicles or other zones thereof which are not shielded by metal, dependent upon the real position of the central control unit 102 in the body of the vehicle, and the positions of the antennas in the center console. As compared with omnidirectional antennas, there will be higher efficiency of signal transmission and a better communication effect of the directional antennas.

In an embodiment of the disclosure, the periphery of the casing of the center console can be embodied as four sides of a square casing or can be embodied as the periphery of a circular or elliptic casing. The casing of the center console in the embodiment of the disclosure will not be limited thereto.

As illustrated in FIG. 1, the central control unit 102 can be arranged on a second PCB, where the plurality of LTE modules 1021 and the CPU 1022 are arranged on the second PCB, and the plurality of LTE modules 1021 are connected with the CPU 1022 through wirings on the second PCB. The LTE modules can alternatively be arranged on a third PCB, the LTE modules can be connected with the CPU 1022 in the central control unit 102 on the second PCB via Mini Peripheral Component Interconnect Express (PCIE) interfaces or other Peripheral Component Interconnect (PCI) interfaces.

The central control unit 102 includes N LTE modules 1021, all of which are connected with the CPU 1022, where the more the LTE modules 1021 connected with the CPU 1022, the better the performance of the vehicular antenna system, so that the high-speed communication, e.g., at 10 Gb/s, 20 Gb/s, etc., can he achieved. Signals received by the LTE modules 1021 are transmitted to the CPU 1022 for processing.

In the embodiments of the disclosure, the antenna modules 101 and the central control unit 102 can be arranged in the center console, the wirings between the antenna modules 101 and the central control unit 102 are designed so simple that there are less and shorter bundles of lines to thereby lower a loss of high-frequency power being transmitted so as to guarantee the superior performance.

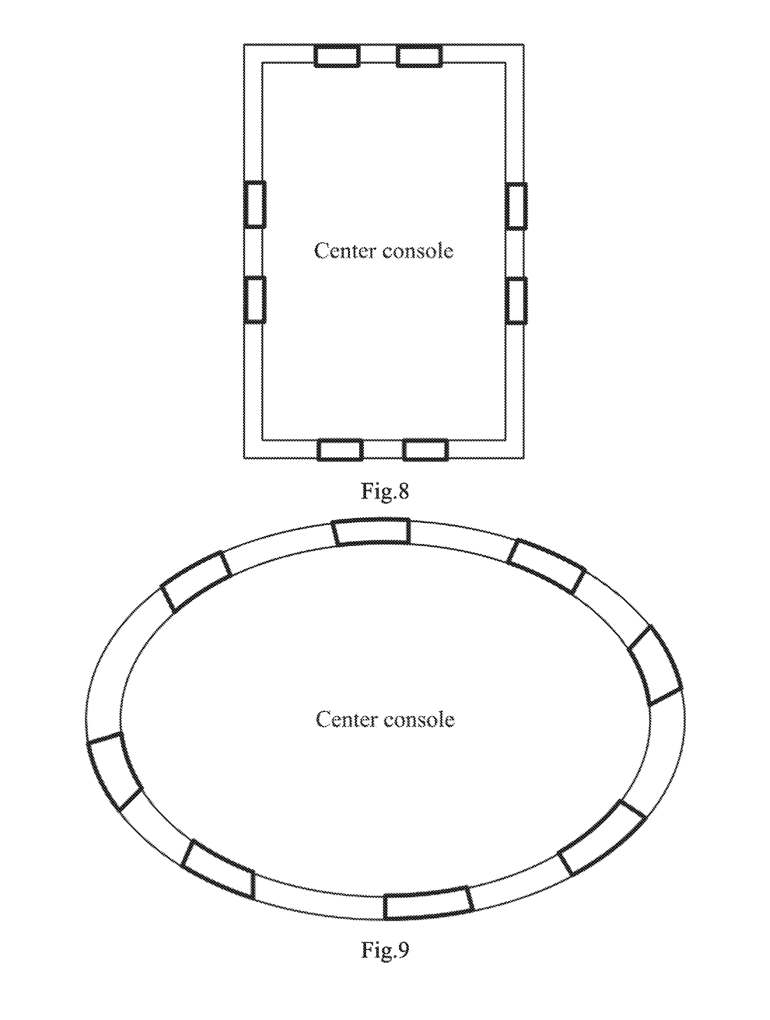

Correspondingly an embodiment of the disclosure further provides a vehicular antenna system, the structure thereof as illustrated in FIG. 10, which includes a central control unit 1002, and a plurality of antenna modules 1001, where the central control unit 1002 includes a CPU 10022 and a plurality of LTE modules 10021, each of the LTE modules 10021 in the central control unit 1002 is connected with at least one of the antenna modules 1001, and the plurality of LTE modules 10021 are connected with the CPU 10022.

A CPU 10022, an FM module 10023, a GPS module 10024, a WiFi/BT module 10025, and a CMMB module 10026 are arranged on a second PCB of the central control unit 1002, and the vehicular antenna system further includes an FM antenna, a GPS antenna, a WiFi/BT antenna and a CMMB antenna respectively corresponding to the FM module 10023, the GPS module 10024, the WiFi/BT module 10025, and the CMMB module 10026. The FM antenna, the GPS antenna, the WiFi/BT antenna and the CMMB antenna are connected with the central control unit 1002 through RF transmission lines.

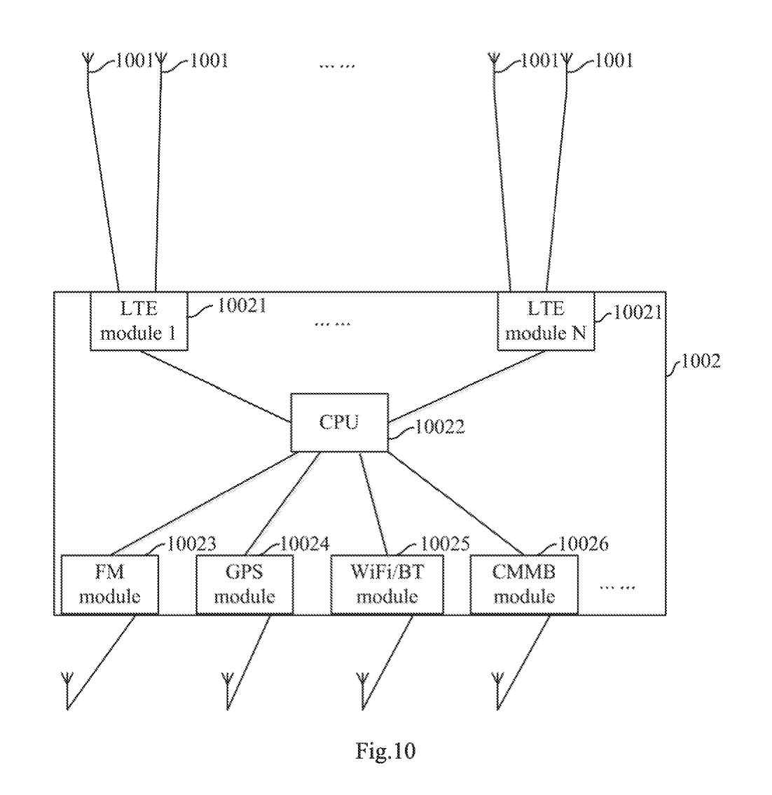

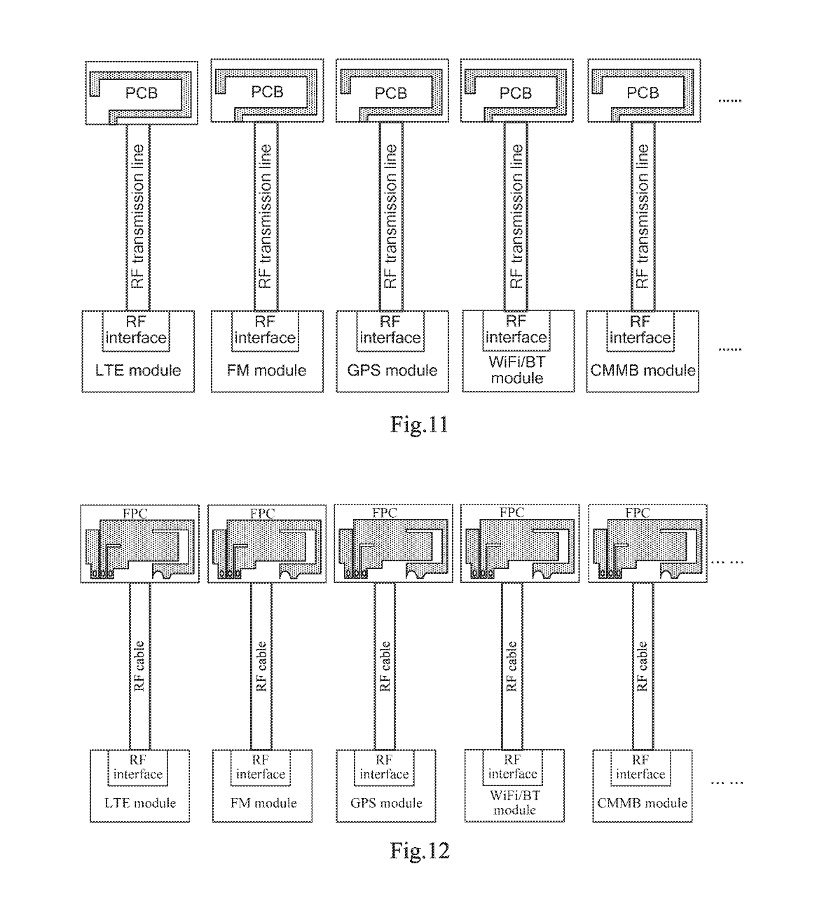

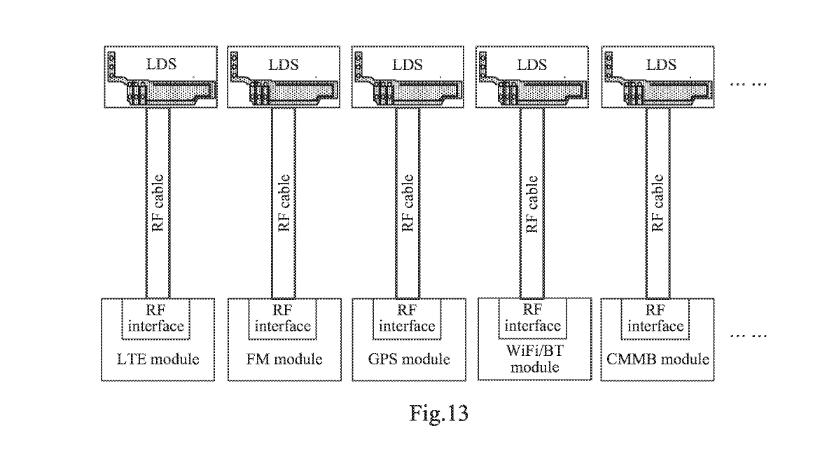

FIG. 11 to FIG. 13 illustrate structural diagrams of the vehicular antenna system including the antenna modules 1001 designed in the three processes respectively. FIG. 11 illustrates a structural diagram of the vehicular antenna system including the antenna modules 1001 in the PCB process, FIG. 12 illustrates a structural diagram of the vehicular antenna system including the antenna modules 1001 in the FPC process, and FIG. 13 illustrates a structural diagram of the vehicular antenna system including the antenna modules 1001 in the LDS process. The particular structures of the vehicular antenna system in FIG. 11 to FIG. 13 have been described in the embodiments above, so a repeated description thereof will be omitted here.

Based upon the same inventive idea, an embodiment of the disclosure further provides a vehicle including the vehicular antenna system above, the particular structure of which has been described in the embodiments above, so a repeated description thereof will be omitted here.

Embodiments of the disclosure provide a vehicular antenna system so as to enable high-speed communication through vehicular antennas which are convenient to install and have good stability.

In the vehicular antenna system according to the embodiments of the disclosure, the plurality of antenna modules can be connected with the plurality of LTE modules in the central control unit to thereby enable high-speed communication through the antennas of the vehicle, and the LTE modules can be arranged in the central control unit to thereby shorten the length of a bundle of lines so as to lower the attenuation of a signal, to improve the efficiency of transmission, and to lower the power consumption.

It shall be noted that the embodiments above are only intended to illustrate the technical solutions of the disclosure, but not to limit the disclosure; and although the disclosure has been described in details with reference to the embodiments above, those ordinarily skilled in the art shall appreciate that they still can modify the technical solutions recited in the respective embodiments above or make equivalent substitutions to a part of the technical features thereof; and the essences of the respective technical solutions will not depart from the spirit and scope of the technical solutions in the respective embodiments of the disclosure due to these modifications or substitutions.

1. A vehicular antenna system, comprising a central control unit and a plurality of antenna modules, wherein:
the central control unit comprises a central processing unit and a plurality of Long Term Evolution (LTE) modules;
each of the LTE modules in the central control unit is connected with at least one of the antenna modules; and
the plurality of LTE modules are connected with the central processing unit.

2. The vehicular antenna system according to claim 1, wherein the antenna modules are formed by being printed on first Printed Circuit Boards (PCBs).

3. The vehicular antenna system according to claim 1, wherein the antenna modules are formed by etching flexible circuit boards, and the antenna modules are affixed on a casing of a center console of a vehicle.

4. The vehicular antenna system according to claim 1, wherein the antenna modules are formed on a casing of a center console of a vehicle by laser carving with a Laser Direct Structuring (LDS) process.

5. The vehicular antenna system according to claim 1, wherein the LTE modules are arranged on a second PCB; and
the LTE modules are connected with the central processing unit through wirings of the second PCB.

6. The vehicular antenna system according to claim 1, wherein the central control unit is connected with each of the antenna modules through Radio Frequency (RF) connection lines.

7. The vehicular antenna system according to claim 1, wherein the plurality of antenna modules and the central control unit are located in an area of a center console of a vehicle.

8. The vehicular antenna system according to claim 7, wherein the plurality of antenna modules are located at corners of a casing of the center console of the vehicle.

9. The vehicular antenna system according to claim 7, wherein the plurality of antenna modules are located on the periphery of a casing of the center console of the vehicle.

10. A vehicle, comprising a vehicular antenna system, wherein the vehicular antenna system comprising a central control unit and a plurality of antenna modules, wherein:
the central control unit comprises a central processing unit and a plurality of Long Term Evolution (LTE) modules;
each of the LTE modules in the central control unit is connected with at least one of the antenna modules; and
the plurality of LTE modules are connected with the central processing unit.

11. The vehicle according to claim 10, wherein the antenna modules are formed by being printed on first Printed Circuit Boards (PCBs).

12. The vehicle according to claim 10, wherein the antenna modules are formed by etching flexible circuit boards, and the antenna modules are affixed on a casing of a center console of a vehicle.

13. The vehicle according to claim 10, wherein the antenna modules are formed on a casing of a center console of a vehicle by laser carving with a Laser Direct Structuring (LDS) process.

14. The vehicle according to claim 10, wherein the LTE modules are arranged on a second PCB; and
the LTE modules are connected with the central processing unit through wirings of the second PCB.

15. The vehicle according to claim 10, wherein the central control unit connected with each of the antenna modules through Radio Frequency (RF) connection lines.

16. The vehicle according to claim 10, wherein the plurality of antenna modules and the central control unit are located in an area of a center console of a vehicle.

17. The vehicle according to claim 16, wherein the plurality of antenna modules are located at corners of a casing of the center console of the vehicle.

18. The vehicle according to claim 16, wherein the plurality of antenna modules are located on the periphery of a casing of the center console of the vehicle.
